(19) United States
(12) Patent Application Publication
(10) Pub. No.: US 2026/0322992 A1
(43) Pub. Date: Oct. 15, 2026

(54) DISPLAY CONTROL DEVICE AND DISPLAY CONTROL METHOD

(71) Applicant: SONY GROUP CORPORATION, TOKYO (JP)

(72) Inventors: TSUYOSHI ISHIKAWA, TOKYO (JP); KEIJIROH NAGANO, TOKYO (JP); HIROSHI YUASA, TOKYO (JP); IKUO YAMANO, TOKYO (JP)

(21) Appl. No.: 19/117,229

(22) PCT Filed: Sep. 25, 2023
(86) PCT No.: PCT/JP2023/034684

§ 371 Date: Mar. 31, 2025

(30) Foreign Application Priority Data
Oct. 4, 2022 (JP) 2022-160170

(51) Int. Cl. H04N 13/393; H04N 13/00; H04N 13/111; H04N 13/398

(52) U.S. Cl. CPC H04N 13/393; H04N 13/111; H04N 13/398; H04N 2013/0085

(57) ABSTRACT

A display control device according to an aspect of the present disclosure includes an acquisition unit that acquires position and orientation information in a three-dimensional space from a first controller, and a display control unit that displays a virtual coordinate plane on which two-dimensional coordinates are allowed to be designated in the three-dimensional space based on the position and orientation information in the three-dimensional space. The display control device may further include a first detection unit that detects a movement of the virtual coordinate plane in a three-dimensional space based on an input by the first controller.

### FIELD

The present disclosure relates to a display control device and a display control method of performing operation control on a virtual object.

### BACKGROUND

With development of video display technology, it is possible to construct a virtual space, superimpose content in the virtual space on a real space, and stereoscopically view a virtual object like a real object by using a device for virtual reality (VR) or augmented reality (AR).

In relation to such a technology, in order for a user to create and edit a 3D model corresponding to a virtual object while stereoscopically viewing the 3D model, many user interfaces (UIs) have been proposed that enable an operation (degree of freedom (6DoF) operation) of holding a controller and moving the model in the air and placing or moving a point or a line in the air. As an example, a technique for improving the operability of the user by devising a mechanism for allocating a physical controller to a virtual controller has been proposed (for example, Patent Literature 1).

### CITATION LIST

### Patent Literature

Patent Literature 1: JP 6859422 B

### SUMMARY

### Technical Problem

However, there is still room for improvement in an operation for selecting or editing a virtual object in a three-dimensional space.

For example, in a case where the user lifts a hand in the air to operate the controller, a physical load is higher than that of an operation using a controller (mouse or the like) on a conventional tabletop. Therefore, there is a problem that input accuracy decreases due to shaking of the hand or the like. For this reason, there is a current state that it is difficult to use a controller for aerial operation mainly used in VR or AR for creating or editing a 3D model in an application (CAD or the like) in which high input accuracy is required.

Therefore, the present disclosure proposes a display control device and a display control method capable of improving input accuracy.

### Solution to Problem

In order to solve the above problems, a display control device according to an aspect of the present disclosure includes an acquisition unit that acquires position and orientation information in a three-dimensional space from a first controller, and a display control unit that displays a virtual coordinate plane on which two-dimensional coordinates are allowed to be designated in the three-dimensional space based on the position and orientation information in the three-dimensional space.

### BRIEF DESCRIPTION OF DRAWINGS

FIG. 1 is a diagram illustrating an outline of a process of a display control process according to the embodiment.

FIG. 2 is a diagram (1) illustrating an example of a display control process according to the embodiment.

FIG. 3 is a diagram (2) illustrating an example of a display control process according to the embodiment.

FIG. 4 is a diagram illustrating a configuration example of a display control device according to the embodiment.

FIG. 5 is a sequence diagram illustrating a flow of a display control process according to the embodiment.

FIG. 6A is a diagram for describing a device operation according to a first modification.

FIG. 6B is a flowchart illustrating a flow of a display control process according to the first modification.

FIG. 7 is a diagram (1) for describing a display control process according to a second modification.

FIG. 8 is a diagram (2) for describing a display control process according to the second modification.

FIG. 9 is a diagram (3) for describing a display control process according to the second modification.

FIG. 10 is a diagram (1) for describing a display control process according to a third modification.

FIG. 11 is a diagram (2) for describing a display control process according to the third modification.

FIG. 12 is a diagram (3) for describing a display control process according to the third modification.

FIG. 13 is a diagram (4) for describing a display control process according to the third modification.

FIG. 14 is a diagram (5) for describing a display control process according to the third modification.

FIG. 15 is a diagram (6) for describing a display control process according to the third modification.

FIG. 16 is a diagram (7) for describing a display control process according to the third modification.

FIG. 17 is a diagram (8) for describing a display control process according to the third modification.

FIG. 18 is a diagram for describing a display control process according to a fourth modification.

FIG. 19 is a hardware configuration diagram illustrating an example of a computer that implements functions of a display control device.

### DESCRIPTION OF EMBODIMENTS

Hereinafter, the embodiments will be described in detail with reference to the drawings. In the following embodiments, the same parts are denoted by the same reference signs, and a duplicate description will be omitted.

The present disclosure will be described in the order of the following items.
1. Embodiment
1-1. Outline of display control process according to embodiment
1-2. Configuration of display control device according to embodiment
1-3. Procedure of processing according to embodiment
1-4. Modifications
1-4-1. First modification: operation of only one device
1-4-2. Second modification: Adjustment of operational feeling
1-4-3. Third modification: processing of superimposing on real space
1-4-4. Fourth modification: deformation of face based on pointer position
2. Other embodiments
3. Effects of display control device according to present disclosure
4. Hardware configuration

### 1. Embodiment

### 1-1. Outline of Display Control Process According to Embodiment

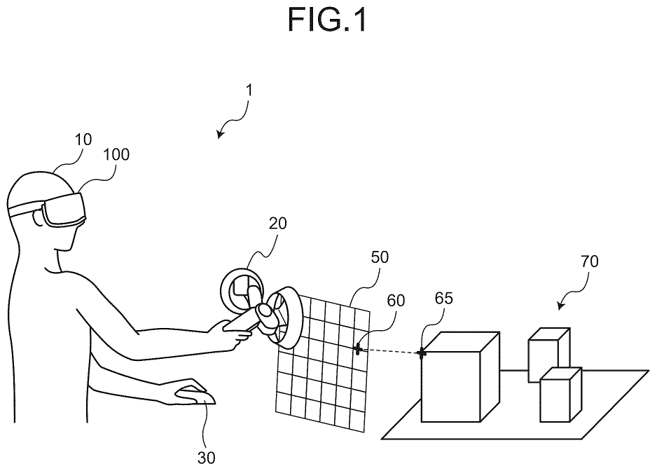

An example of a display control process according to the embodiment will be described with reference to FIG. 1. FIG. 1 is a diagram illustrating an outline of a display control process according to the embodiment. FIG. 1 illustrates components of a display control system 1 that executes a display control process according to the embodiment.

As illustrated in FIG. 1, the display control system 1 includes a display control device 100, a stereoscopic device 20, and a plane device 30.

The display control device 100 is an information processing terminal for realizing a VR or AR technology. In the embodiment, the display control device 100 is a wearable display used by being worn on the head of a user 10. Specifically, the display control device 100 is, for example, a head mounted display (HMD), AR glasses, or the like.

The display control device 100 includes a sealed or transmissive display unit (display). For example, the display control device 100 displays a virtual space expressed by computer graphics (CG) or the like. Alternatively, the display control device 100 superimposes the virtual object expressed by CG or the like on the real space and displays the virtual object on the display unit. In the example of FIG. 1, the display control device 100 displays an object 70 as an example of a virtual object. That is, in the example of FIG. 1, the object 70 and the space visually recognized by the user 10 are assumed to be a virtual space constituted by CG or the like. Note that, as will be described later, the space visually recognized by the user 10 may be a so-called AR space in which a virtual object is superimposed on a real space. In addition, the display control device 100 may have a configuration for outputting a predetermined output signal in addition to the display unit. For example, the display control device 100 may include a speaker or the like for outputting a sound.

The stereoscopic device 20 is an example of an input device according to the embodiment. In the embodiment, the stereoscopic device 20 is operated by the user 10 and used to input various types of information to the display control device 100. The stereoscopic device 20 is a VR controller capable of inputting so-called 6DoF information. Specifically, the stereoscopic device 20 includes a sensor such as an inertial sensor, an acceleration sensor, or a gravity sensor, and detects position and orientation information of the stereoscopic device. Then, the stereoscopic device 20 transmits the detected position and orientation information of the stereoscopic device to the display control device 100.

The stereoscopic device 20 may be a controller held by the user 10 with one hand as illustrated in FIG. 1, or may be a pen-type controller. Note that the stereoscopic device 20 is not limited to the example, and may be any device as long as it can acquire position information in the real space. For example, the stereoscopic device 20 may be an air mouse, a digital camera, a smartphone, or the like. Furthermore, in a case where the display control device 100 can capture the position and orientation information of the stereoscopic device 20, the stereoscopic device 20 may not include the sensor. For example, the stereoscopic device 20 may be a predetermined object including a marker that is allowed to be recognized by the display control device 100 or a predetermined external device (a video camera or the like installed in a real space), a human face, a finger, or the like.

The plane device 30 is an example of an input device according to the embodiment. In the embodiment, the plane device 30 is operated by the user 10 and used to input various types of information to the display control device 100. The plane device 30 is, for example, a mouse controller or a trackball mouse capable of receiving two-dimensional coordinate information. Specifically, the plane device 30 includes a sensor such as an optical sensor, and detects coordinate information (two-dimensional information) on the flat face based on the operation of the plane device. Then, the plane device 30 transmits the detected coordinate information to the display control device 100.

Here, processing when the user 10 designates any position of the object in the VR or AR space will be described. In the related art, a controller such as the stereoscopic device 20 has been used to select a position in the VR or AR space. However, in a case where the controller is operated in the air, a physical load is higher than that in an operation using the controller on a conventional table, so that there is a problem that input accuracy is lowered due to shaking of hands or the like.

As a means for solving such a problem, a technology has also been proposed in which a highly accurate device such as a mouse is allowed to be used in a three-dimensional space. However, since a plane device such as a mouse is used for receiving coordinate information on a specific plane in principle, it is difficult to point at a position on any space with respect to a three-dimensional space. In this regard, processing of using a controller capable of receiving 6DoF information, such as a VR controller, and a mouse in combination is also being sought. However, when two different pointing devices are operated at the same time, a UI operated by one conventional pointer breaks down, and thus, the plurality of devices is normally mounted to operate exclusively. For this reason, a technique for accurately and further improving the operability with respect to the pointing on the three-dimensional space has been desired.

Therefore, the display control device 100 according to the present disclosure solves such a problem with the following configuration. That is, the display control device 100 acquires position and orientation information in a three-dimensional space from a first controller, and displays a virtual coordinate plane on which two-dimensional coordinates are allowed to be designated in the three-dimensional space based on the position and orientation information in the three-dimensional space. Furthermore, the display control device 100 detects coordinates on the virtual coordinate plane from the second controller, thereby enabling the user 10 to accurately select a desired position in the space. In this case, the first controller is the stereoscopic device 20 held by the user 10 in one hand. The second controller is the plane device 30 that the user 10 grips with a hand (for example, the dominant hand of the user 10) different from the hand holding the first controller.

That is, the display control device 100 enables the user 10 to select any position by combining two different devices. Specifically, the display control device 100 displays a virtual coordinate plane (a face 50 illustrated in FIG. 1) in a space, and uses the stereoscopic device 20 as input means for moving the face 50. In addition, the display control device 100 displays a pointer 60 on the face 50, and uses the plane device 30 as an input means for two-dimensionally moving a pointer 60. As a result, after displaying the face 50 at any place (for example, the vicinity of the object 70) in the space, the user 10 performs an input using the plane device 30 capable of designating a fine position of the pointer 60, thereby enabling a pointing operation with high accuracy in the virtual space.

The above display control process will be described with reference to FIG. 1. In the example illustrated in FIG. 1, the display control device 100 displays the face 50 in the virtual space. A virtual handle is set on the face 50, and the user 10 can obtain feedback as if the user grips the handle with the hand and moves the face 50 by operating the stereoscopic device 20 holding the handle.

The user 10 places the face 50 near the object 70. Thereafter, the user 10 operates the plane device 30 placed on the tabletop, and designates the position of the pointer 60 on the face 50. The coordinates on the face 50 and the spatial coordinates on the virtual space are associated with each other. Therefore, the display control device 100 can obtain the intersection with the outer shape (3D model) of the object 70 on the extension line of the position of the pointer 60 based on the position and orientation (angle) of the face 50, for example. In the example of FIG. 1, the display control device 100 obtains spatial coordinates 65, which are any one point of the object 70, as the position corresponding to the pointer 60. That is, the user 10 can point to a specific position of the object 70 by designating the position of the pointer 60 on the face 50. As a result, the user 10 can select a point, a side, a face, or the like to be edited in the object 70 with high accuracy.

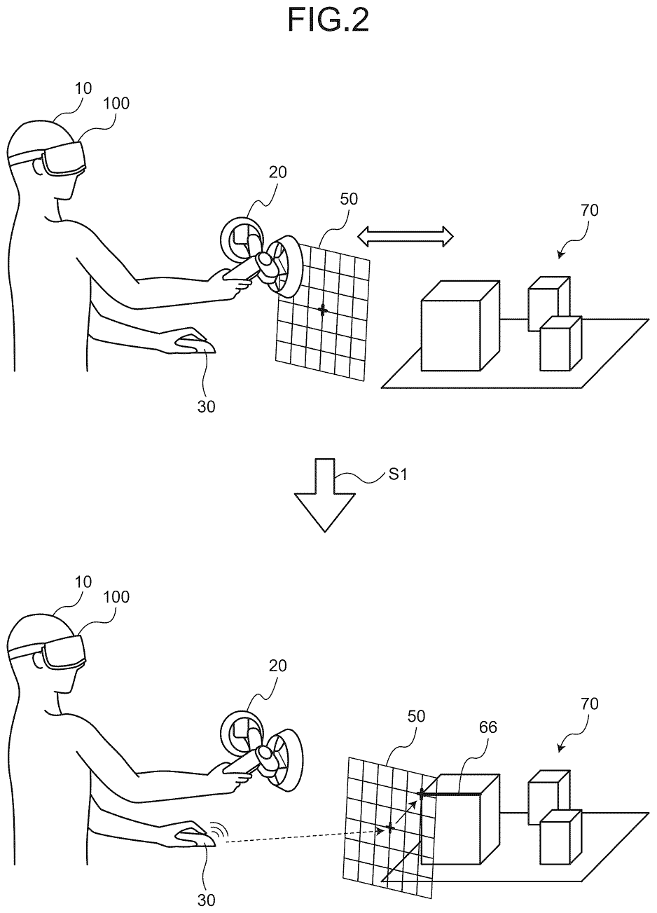

Next, another display example will be described with reference to FIG. 2. FIG. 2 is a diagram (1) illustrating an example of a procedure of the display control process according to the embodiment. The example of FIG. 2 illustrates a state in which the user 10 operates the stereoscopic device 20 (step S1) and moves the face 50 in a direction toward the object 70 same as that in FIG. 1.

In this manner, the user 10 can more accurately designate a specific position of the object 70 by moving the face 50 to a position almost in contact with the object 70. The example of FIG. 2 illustrates a situation in which the user 10 moves the face 50 and then operates the plane device 30 to select a specific side 66 of the object 70.

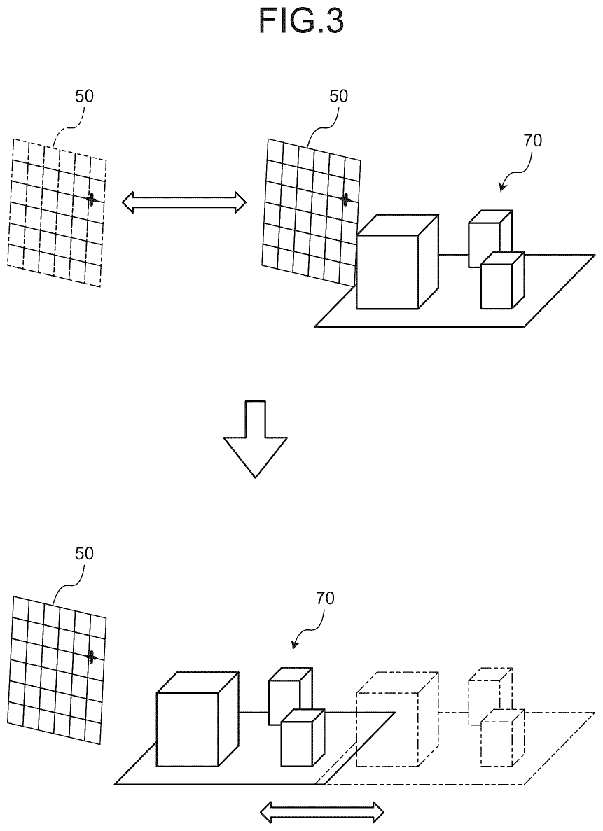

Next, another display example will be described with reference to FIG. 3. FIG. 3 is a diagram (2) illustrating an example of a procedure of the display control process according to the embodiment. In the example illustrated in the upper part of FIG. 3, as in FIG. 2, a state is illustrated in which the user 10 operates the stereoscopic device 20 to move the face 50 in the direction toward the object 70.

On the other hand, in the example illustrated in the lower part of FIG. 3, the position of the face 50 is fixed by the operation by the user 10. In this case, the user 10 can switch the operation target to the object 70 and perform an operation to bring the object 70 close to the face 50. Also by such means, since the user 10 can bring the face 50 and the object 70 relatively close to each other, it is possible to perform an accurate input.

As described above with reference to FIGS. 1 to 3, according to the display control process according to the embodiment, by displaying the face 50 in the space, it is possible to perform position designation in the space by using the stereoscopic device 20 and the plane device 30 in combination, and thus, it is possible to improve operability and input accuracy.

Note that each device in FIG. 1 conceptually illustrates a function in the display control system 1, and can take various modes depending on the embodiment. For example, the display control device 100 may include two or more devices different for each function to be described later. Specifically, the display control device 100 may be a device in which the display unit and the information processing unit are separately configured. In this case, the information processing unit of the display control device 100 may be any information processing device such as a server or a personal computer (PC).

### 1-2. Configuration of Display Control Device According to Embodiment

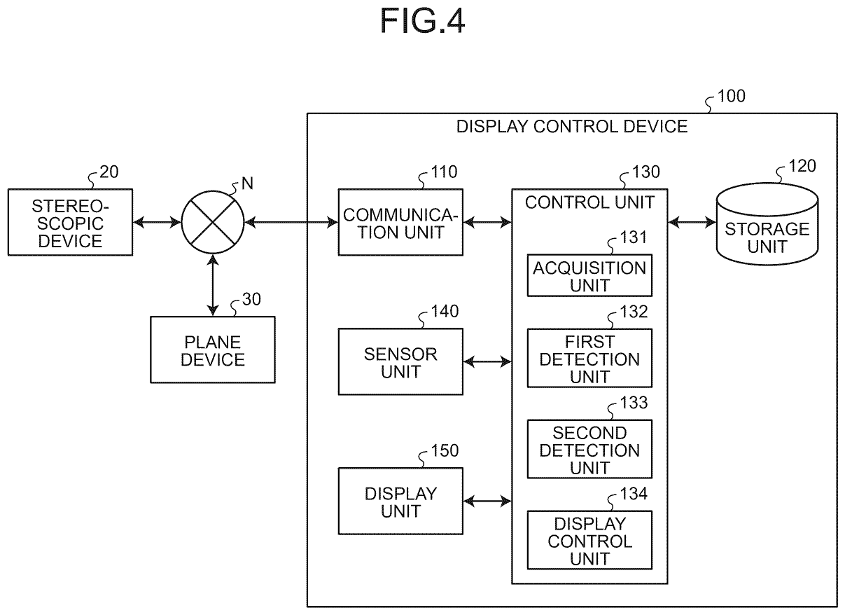

Next, a configuration of the display control device 100 will be described. FIG. 4 is a diagram illustrating a configuration example of the display control device 100 according to the embodiment.

As illustrated in FIG. 4, the display control device 100 includes a communication unit 110, a storage unit 120, a control unit 130, a sensor unit 140, and a display unit 150. Note that the display control device 100 may include an input unit (an operation button, a touch panel, or the like) that receives various operations from the user 10 who operates the display control device 100.

The communication unit 110 is realized by, for example, a network interface card (NIC), a network interface controller, or the like. The communication unit 110 is connected to a network N in a wired or wireless manner to transmit and receives information to and from the stereoscopic device 20, the plane device 30, and the like via the network N. The network N is realized by, for example, a wireless communication standard or system such as Bluetooth (registered trademark), the Internet, Wi-Fi (registered trademark), an ultra wide band (UWB), or a low power wide area (LPWA).

The storage unit 120 is realized by, for example, a semiconductor memory element such as a random access memory (RAM) and a flash memory, or a storage device such as a hard disk and an optical disk.

The storage unit 120 stores various types of information related to the display control process according to the embodiment. For example, the storage unit 120 stores a 3D model or the like of the virtual object displayed on the display unit 150.

The sensor unit 140 is a sensor that detects various environmental information. For example, the sensor unit 140 includes an outward camera that captures an image of the outside of the display control device 100 and an inward camera that captures an image of the user 10 side.

For example, the sensor unit 140 has a function as a recognition camera for recognizing the space in front of the eyes of the user. For example, the sensor unit 140 recognizes the position of the stereoscopic device 20 in the space by imaging the stereoscopic device 20 whose spatial position has been calibrated in advance, and acquires the position and orientation information of the stereoscopic device 20.

Furthermore, the sensor unit 140 recognizes a subject (for example, a real object located in a real space) located in front of the display control device 100. In this case, the sensor unit 140 can acquire an image of a subject located in front of the user and calculate the distance from the display control device 100(in other words, the position of the viewpoint of the user) to the subject based on parallax between images captured by the stereo camera. Alternatively, the sensor unit 140 may detect the distance in the real space using a depth sensor capable of detecting the distance to the real object.

Furthermore, in addition to the function as a recognition camera, the sensor unit 140 may have a function of detecting various types of information about the motion of the user, such as the orientation, inclination, movement, and movement speed of the user's body. Specifically, the sensor unit 140 detects, as the information about the motion of the user, information about the head and orientation of the user, the motion (acceleration and angular velocity) of the head and body of the user, the direction of the visual field, the speed of viewpoint movement, and the like. For example, the sensor unit 140 functions as various motion sensors such as a three-axis acceleration sensor, a gyro sensor, and a speed sensor, and detects information about the user's motion. More specifically, the sensor unit 140 detects respective components in a yaw direction, a pitch direction, and a roll direction as the movement of the head of the user, thereby detecting a change in at least any one of the position and the orientation of the head of the user. Note that the sensor unit 140 is not necessarily provided in the display control device 100, and may be, for example, an external sensor connected to the display control device 100 in a wired or wireless manner.

The display unit 150 displays various types of information output from the control unit 130. For example, the display unit 150 is a display that outputs a video to the user 10. Note that the display unit 150 may include a sound output unit (speaker or the like) that outputs sound.

The control unit 130 is implemented by, for example, a central processing unit (CPU), a micro processing unit (MPU), a GPU, or the like executing a program stored inside the display control device 100 using a RAM or the like as a work area. The control unit 130 may be a controller, and may be realized by an integrated circuit such as an application specific integrated circuit (ASIC) or a field programmable gate array (FPGA).

As illustrated in FIG. 4, the control unit 130 includes an acquisition unit 131, a first detection unit 132, a second detection unit 133, and a display control unit 134.

The acquisition unit 131 acquires various types of information. For example, the acquisition unit 131 acquires the position and orientation information in the three-dimensional space from the stereoscopic device 20 which is the first controller. In addition, the acquisition unit 131 acquires position information, which is information indicating a position on the face 50, from the plane device 30, which is the second controller.

The first detection unit 132 detects the movement of the face 50 in the three-dimensional space based on the input by the stereoscopic device 20. Specifically, the first detection unit 132 combines the image of the stereoscopic device 20 captured by the sensor unit 140 with the position and orientation information transmitted from the stereoscopic device 20 to detect (calculate) the position and orientation information of the stereoscopic device 20 in the space. That is, the position and orientation information of the stereoscopic device 20 is obtained by merging image information obtained by imaging the stereoscopic device 20 with the outward camera of the sensor unit 140 and inertial measurement unit (IMU) information included in the stereoscopic device 20. Note that the input by the stereoscopic device 20 means that the position and orientation information (or its variation value) measured by the IMU or the like by the operation of the stereoscopic device 20 in the space is input to the display control device 100 via the communication unit 110.

For example, the first detection unit 132 detects the movement and the position and orientation information of the face 50 by the user 10 operating the stereoscopic device 20 while holding the handle virtually provided on the face 50 and detecting the variation value of the position and orientation information obtained based on the operation result.

In addition to the above processing, various known techniques may be used to detect the position of the stereoscopic device 20. For example, in a case where an infrared light emitting diode (LED) is embedded in the stereoscopic device 20, the first detection unit 132 can detect the position and orientation of the stereoscopic device 20 by observing a state in which the infrared LED is emitted with an outward camera of the sensor unit 140 and combining IMU information. Furthermore, the first detection unit 132 can also detect the position and orientation of the stereoscopic device 20 by estimating the position and orientation of the hand by imaging the hand of the user 10 with the camera of the sensor unit 140, a camera installed in the room, or the like using the hand track technology.

The first detection unit 132 may detect the relative movement of the face 50 instead of the movement of the face 50 itself. That is, the first detection unit 132 may detect the movement of the object whose position is allowed to be designated using the face 50 based on the input by the stereoscopic device 20. In this case, the first detection unit 132 receives designation of an object to be moved by the user 10, and performs a process of moving the object closer to or away from the face 50 according to the operation by the user 10.

The second detection unit 133 detects the position (for example, the position of the pointer indicating the designated position) designated by the face 50 based on the input by the plane device 30 as the second controller. Since the face 50 is given the position and orientation information (inclination of the plane, etc.) in the space based on the operation of the stereoscopic device 20, the pointer located on the face 50 includes not only the two-dimensional position (coordinates of the face 50) but also the position and orientation information corresponding to the face 50.

In addition, the second detection unit 133 detects a part selected in the object based on the position designated on the face 50. For example, the second detection unit 133 detects a part such as a point, a side, or a face of the object corresponding to the position indicated by the pointer based on designation or initial setting by the user 10.

At this time, the second detection unit 133 may detect the selected part in the object based on the relationship between the angle of the face 50 and the position of the pointer and the position of the object. Specifically, the second detection unit 133 detects a point intersecting with the object on the extension line of the pointer obtained from the angle of the face 50 and the position of the pointer as the part designated by the user 10.

For example, the second detection unit 133 may detect a point intersecting with the object on the extension line in the normal direction with respect to the face 50 as the part designated by the user 10 with the pointer position as the starting point. Alternatively, the second detection unit 133 may detect a point intersecting with the object on an extension line of a line connecting the viewpoint position of the user 10 and the pointer position as the part designated by the user 10. Alternatively, regardless of the angle of the face 50, the second detection unit 133 may detect a part selected in the object based on a position intersecting with the object on a line horizontally extending from a pointer position designated on the face 50.

The display control unit 134 causes the display unit 150 to display the information output from the control unit 130. That is, the display control unit 134 outputs the virtual space video rendered as the video content to the output destination device. Note that the output destination device is not limited to a head mounted display such as the display unit 150, and may be a video output device such as an external display, a smartphone, or a television.

For example, the display control unit 134 displays a face 50, which is a virtual coordinate plane on which two-dimensional coordinates are allowed to be designated, in the three-dimensional space based on the position and orientation information in the three-dimensional space of the stereoscopic device 20.

In addition, the display control unit 134 performs control to display a pointer on the face 50 based on the position information on the face 50 input from the plane device 30. Furthermore, in a case where any part is selected in the object based on the pointer position, the display control unit 134 clearly indicates the selected position.

### 1-3. Procedure of Processing According to Embodiment

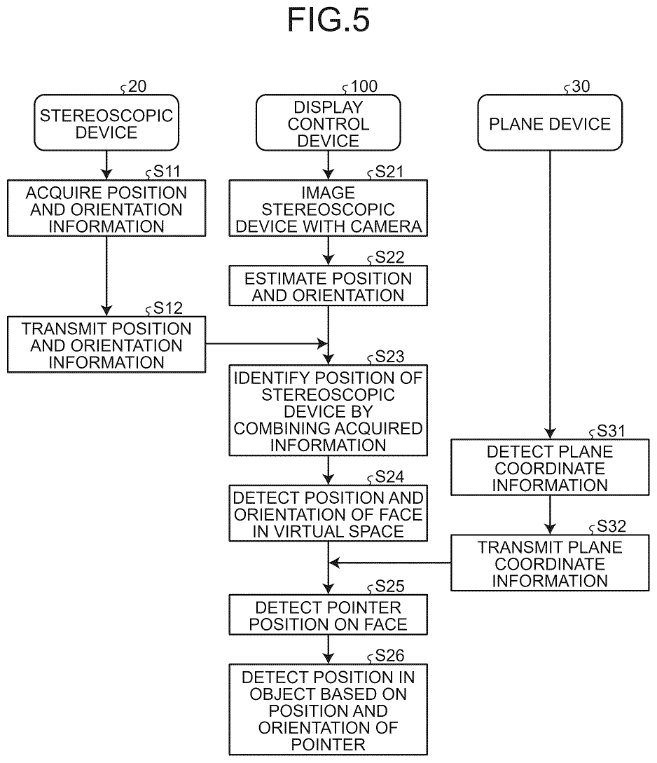

A procedure of processing according to the embodiment will be described with reference to FIG. 5. FIG. 5 is a sequence diagram illustrating a flow of a display control process according to the embodiment.

As illustrated in FIG. 5, the stereoscopic device 20 acquires the position and orientation information of the stereoscopic device using the IMU or the like (step S11). Then, the stereoscopic device 20 transmits the acquired position and orientation information to the display control device 100 (step S12).

The display control device 100 images the stereoscopic device 20 using an outward camera or the like (step S21). Then, the display control device 100 estimates the position and orientation of the stereoscopic device 20 (step S22).

Thereafter, the display control device 100 identifies the position and orientation of the stereoscopic device 20 by combining the position and orientation information acquired from the stereoscopic device 20 with the position and orientation information obtained by imaging (step S23). The display control device 100 detects the position and orientation of the face 50 in the virtual space based on the position and orientation information of the stereoscopic device 20 (step S24). The display control device 100 displays the face 50 on the display unit 150 based on the detected position and orientation of the face 50.

When the position of the face 50 is determined, the plane device 30 acquires plane coordinate information for identifying the position on the face 50 (step S31). Then, the plane device 30 transmits the acquired plane coordinate information to the display control device 100 (step S32).

The display control device 100 detects the pointer position on the face 50 based on the information acquired from the plane device 30 (step S25). Then, the display control device 100 detects the position designated by the user 10 in the object based on the position and orientation of the pointer (step S26). Note that the orientation information of the pointer in this case is obtained based on the angle of the face 50, for example.

### 1-4. Modifications

### 1-4-1. First Modification: Operation of Only One Device

The processing according to the above embodiment may be accompanied by various modifications. For example, in the above embodiment, an example is described in which the user 10 operates the face 50 and the pointer using both the stereoscopic device 20 and the plane device 30. However, the user 10 can also cause the information processing according to the embodiment to be executed using any one of the devices.

That is, the display control device 100 can perform the display control process according to the present disclosure even if the first controller (stereoscopic device 20) and the second controller (plane device 30) are the same device. In this case, in a case where the same device is located at a position away from the plane in the real space by a predetermined distance, the first detection unit 132 detects the same device as the first controller. In addition, in a case where the same device is located within a predetermined distance from a plane in the real space, the second detection unit 133 detects the same device as the second controller.

Alternatively, in a case of receiving designation to use the same device as the first controller from the user 10 of the same device, the first detection unit 132 may detect the same device as the first controller. Further, in a case of receiving designation to use the same device as the second controller from the user 10 of the same device, the second detection unit 133 may detect the same device as the second controller.

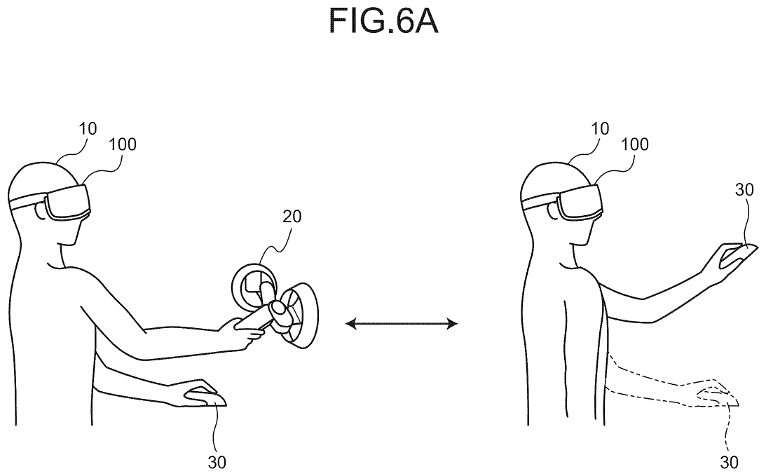

The above processing will be described with reference to FIGS. 6A and 6B. FIG. 6A is a diagram for describing a device operation according to a first modification.

In the left part of FIG. 6A, the user 10 operates the stereoscopic device 20 and the plane device 30 as in the embodiment.

On the other hand, in the right part of FIG. 6A, the user 10 operates only the plane device 30. In this case, in a case where the plane device 30 is lifted from the tabletop, the display control device 100 recognizes the operation. Then, in a case where the plane device 30 is in the air, the display control device 100 recognizes the plane device 30 as a device that performs the same operation as the stereoscopic device 20. Specifically, in a case where the plane device 30 is in the air, the display control device 100 recognizes the movement of such a device as a device for moving the face 50.

Then, in a case where the user 10 places the plane device 30 on the tabletop, the display control device 100 recognizes the plane device 30 as a device for operating a pointer on the face 50. With such processing, the user 10 can realize the processing according to the embodiment with only one device.

Note that the display control device 100 can use the stereoscopic device 20 in the same manner as the plane device 30. For example, in a case where the stereoscopic device 20 is moved to the vicinity of the tabletop, the display control device 100 recognizes the movement and uses the stereoscopic device 20 as the plane device 30. More specifically, in a case where the stereoscopic device 20 is located in the vicinity of the tabletop, the display control device 100 invalidates the input of the position and orientation from the stereoscopic device 20, and can use the stereoscopic device as the plane device 30 that touches the desk to receive the position information like a touch pen.

Note that, in a case where the processing according to the embodiment is performed only by one device, the display control device 100 may explicitly receive the switching operation from the user 10 other than the above processing. For example, in a case where the stereoscopic device 20 has a function (track ball or the like) capable of identifying the two-dimensional position, the user 10 can flexibly perform the above switching.

Furthermore, in a case where the display unit 150 of the display control device 100 is allowed to be temporarily removed to the upper portion (referred to as flip-up or the like), the display control device 100 may use the stereoscopic device 20 as the plane device 30 during flip-up. This is because the user 10 cannot perform stereoscopic viewing during flip-up.

A flow of the above processing will be described with reference to FIG. 6B. FIG. 6B is a flowchart illustrating a flow of a display control process according to the first modification.

The display control device 100 determines whether the two devices that operates the face 50 and performs the pointer operation are different devices (step S41). In the case of different devices (step S41; Yes), as in the embodiment, the display control device 100 sets the movement according to the original setting in each device.

In a case where the two devices that operates the face 50 and performs the pointer operation are not different devices (step S41; No), the display control device 100 determines whether the device is recognized on a tabletop (on any plane in a three-dimensional space) (step S42). When the device is on the tabletop (step S42; Yes), the display control device 100 uses the device as the plane device 30.

On the other hand, in a case where the device is not on the tabletop (step S42; No), the display control device 100 determines whether the user 10 designates the device as the plane device 30 (step S43). In a case where the user 10 designates the device as the plane device 30 (step S43; Yes), the display control device 100 uses the device as the plane device 30.

On the other hand, when the device is not designated as the plane device 30 (step S43; No), the display control device 100 determines whether the HMD is flipped up (step S44).

In a case where the HMD is not flipped up (step S44; No), the display control device 100 uses the device as the stereoscopic device 20. On the other hand, in a case where the HMD is flipped up (step S44; Yes), the display control device 100 uses the device as the plane device 30.

### 1-4-2. Second Modification: Adjustment of Operation Feeling

In the above embodiment, an example in which the user 10 moves the face 50 by operating the stereoscopic device 20 is described. For example, a virtual handle is provided on the face 50, and the user 10 can move the face 50 as if it were a real object by operating the stereoscopic device 20 to grip the handle. However, in the virtual space, a situation is assumed in which it is desired to move the face 50 farther than the distance actually reached by the user 10. Alternatively, in the virtual space, a situation is assumed in which the face 50 is installed farther than the distance by which the user 10 extends the hand, and the hand cannot be held.

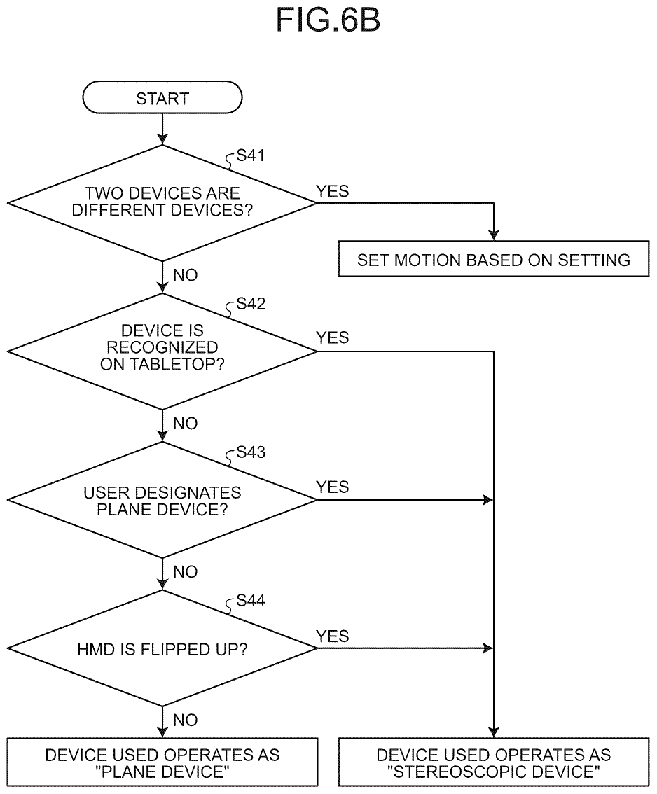

Processing in such a situation will be described with reference to FIG. 7. FIG. 7 is a diagram (1) for describing a display control process according to a second modification. In the left part of FIG. 7, as in the embodiment, the user 10 grips the handle of the face 50 with a hand and moves the hand by a distance 200 to move the face 50.

On the other hand, in the right part of FIG. 7, the user 10 desires to move the face 50 farther than the distance 205 by which the hand is actually moved. In this case, the display control device 100 provides a guide to the user 10 by, for example, displaying a ray in a direction from the hand toward the face 50 on the virtual space. For example, the user 10 can cause the guide to be displayed by explicitly selecting a display mode set in advance by the display control device 100, such as a remote control mode. In this case, the display control device 100 may move the face 50 by a distance longer than the actual movement distance of the hand only by the movement of the hand of the user 10 without the user 10 holding the hand of the face 50.

Furthermore, in a case where the face 50 is installed far away, the display control device 100 may operate as if the user 10 grasps the handle based on a guide extended from the hand, and move the face 50.

Furthermore, in a case where the user 10 grips a region, in the space, that is not the handle of the face 50, the display control device 100 may perform display control to move the object instead of the face 50 as illustrated in FIG. 3.

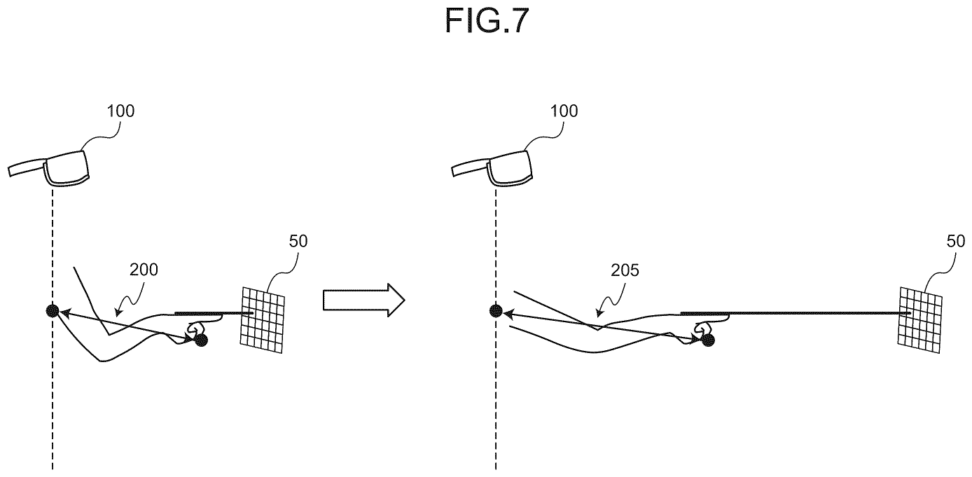

Furthermore, the display control device 100 may perform control so that not only the face 50 but also the object is allowed to be remotely operated. This point will be described with reference to FIG. 8. FIG. 8 is a diagram (2) for describing the display control process according to the second modification.

In the example of FIG. 8, the display control device 100 displays a guide 210 that penetrates the face 50 and grasps the object 70. The user 10 can grasp and select the object 70 via the guide 210. As a result, the user 10 can perform an operation such as grasping or moving even on the object 70 installed at a position that cannot be reached by the hand in the virtual space.

Note that, in a case where the user 10 desires to select a portion of the object 70, when the object 70 and the face 50 are in contact with each other, a situation may occur in which a portion of the object 70 in contact is allowed to be selected, but a part not in contact cannot be selected. In this case, the display control device 100 may output a ray (guide) in a specific direction from the pointer on the face by switching the operation mode of the pointer, so that a portion of the object 70 is allowed to be selected. The specific direction is, for example, a direction that is allowed to be determined based on the viewpoint position of the user 10 and the pointer position, such as a normal direction with respect to the face 50 or a direction connecting the viewpoint position of the user 10 and the pointer. Furthermore, in order to make it easy for the user 10 to select a portion of the object 70, the display control device 100 may move the pointer on the face to the contact part when the object 70 and the face 50 come into contact with each other from a state where the object and the face are not in contact with each other.

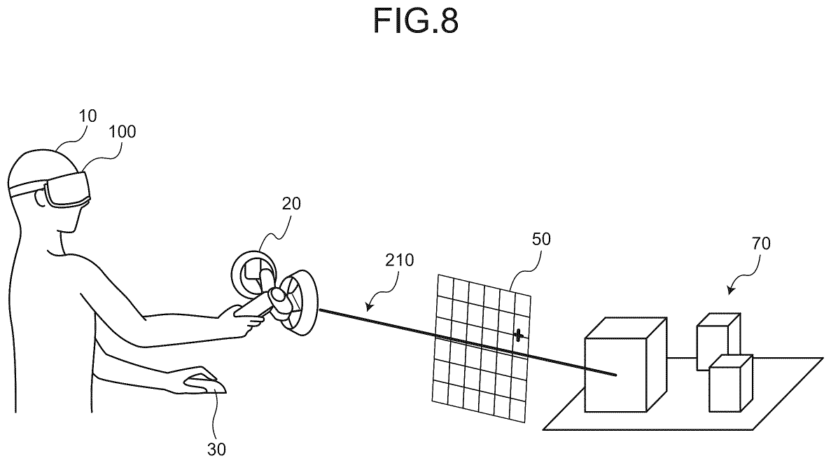

Furthermore, the display control device 100 may fix the position of the face 50 so as not to move to a position where the face 50 cannot be held in the virtual space. That is, the display control unit 134 may display the face 50 in the three-dimensional space based on the viewpoint position of the user 10 regardless of the position and orientation information of the stereoscopic device 20 in the three-dimensional space. This point will be described with reference to FIG. 9. FIG. 9 is a diagram (3) for describing the display control process according to the second modification.

In the example of FIG. 9, the display control device 100 performs control to display the face 50 at a certain distance 215 from the display control device 100. In this case, the face 50 moves in conjunction with the movement of the display control device 100. As a result, the user 10 can move the face 50 for selecting any position of the object 70 by directing the line of sight toward the object 70 without using the stereoscopic device 20. Note that, when the face 50 constantly moves in conjunction with the display control device 100, it is difficult to keep the face 50 at a constant position, and thus the display control device 100 may turn on or off the automatic movement of the face 50 in response to a request from the user 10.

Note that the display control device 100 may change the size as well as changing the position and orientation of the face 50. For example, the display control device 100 changes the size of the face 50 in conjunction with an operation or the like in which the user 10 rotates the mouse wheel. Furthermore, the display control device 100 may change the color of the face 50.

Furthermore, the display control device 100 may perform processing of cutting out a cross section of an object in the virtual space, processing of hiding an object even slightly in a region before the face 50, and the like according to the position where the face 50 is installed. That is, the display control device 100 may change the display content of the object according to the position of the face 50. As a result, the display control device 100 can improve the visibility of the object.

### 1-4-3. Third Modification: Processing of Superimposing on Real Space

Furthermore, the display control device 100 may superimpose the face 50 on the real space as in the AR display. In this case, the display control device 100 may adjust the movement so that the user can easily adjust the position by snapping the face 50 to the face or side of the object in the real world. That is, when the display control unit 134 displays the face 50 in the three-dimensional space of the real space, the first detection unit 132 may detect, based on the input by the stereoscopic device 20, in a case where the face 50 approaches any plane in the real space by a predetermined distance, the face 50 at a position attracted (snapped) to the plane so that the face 50 is displayed to be superimposed on the plane.

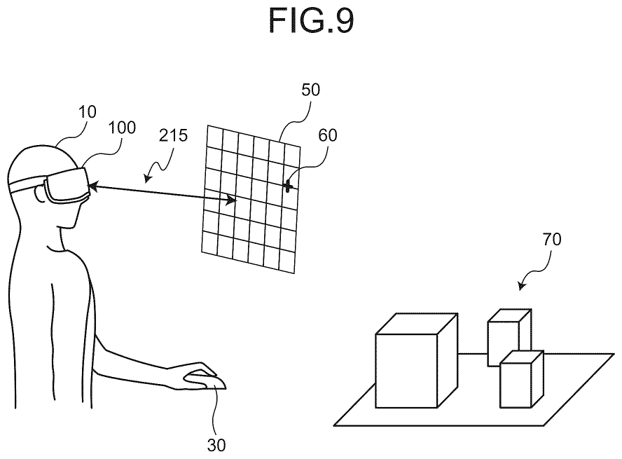

This point will be described with reference to FIG. 10 and subsequent drawings. FIG. 10 is a diagram (1) for describing the display control process according to the third modification.

FIG. 10 illustrates a state in which the face 50 is superimposed on the real space. Specifically, the example of FIG. 10 illustrates a state in which the face 50 provided with a handle 220 is displayed so as to be stuck to the screen of a real display 225. Note that, in a case where the plane to which the face 50 is snapped is recognized, the display control device 100 displays a guide 230 along the plane (outer frame of the display 225 in this example).

For example, when the user 10 grips the handle 220 and brings the face 50 close to the display 225, the display control device 100 recognizes that the display 225 and the face 50 have come close within a predetermined distance, and causes the face 50 to snap to the display 225 along the guide 230.

As a result, the user 10 can use the closely attached face 50 when selecting an object or the like to be projected on the display 225, so that the selection operation or the like is allowed to be accurately performed even in the AR space. Note that the display control device 100 may attach the face 50 to a side face adjacent to the screen instead of the front face of the display 225 but t. As a result, the user 10 can use the display 225 as a normal monitor and perform an operation or the like on the face 50 virtually displayed beside the display.

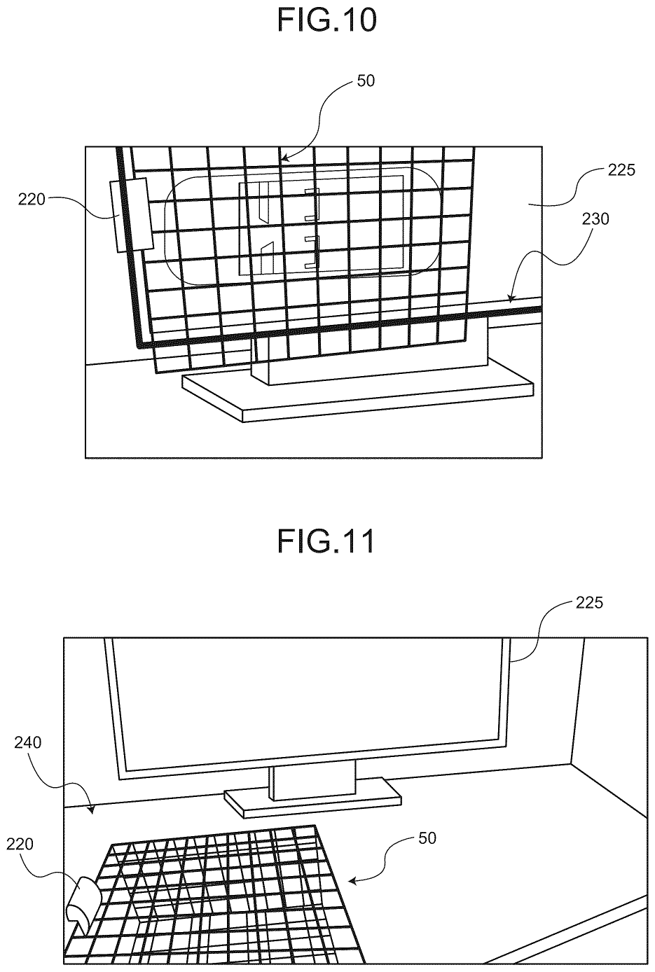

Another example will be described with reference to FIG. 11. FIG. 11 is a diagram (2) for describing the display control process according to the third modification.

In the example of FIG. 11, the display control device 100 recognizes the desk 240 as a plane to which the face 50 is attached. That is, when the user 10 grips the handle 220 and brings the face 50 close to a desk 240, the display control device 100 recognizes that the upper face of the desk 240 and the face 50 have come close within a predetermined distance, and causes the face 50 to snap to the upper face of the desk 240.

As a result, the user 10 can use the display 225 as a normal monitor and use the desk 240 on which the display 225 is placed as another area for performing other work.

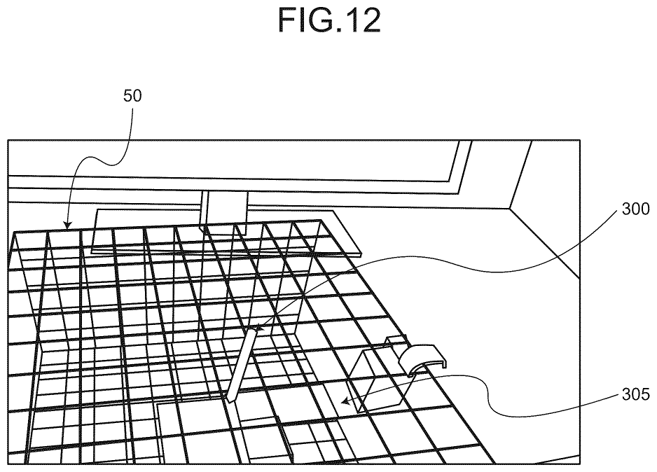

Furthermore, information process on the face 50 disposed on the tabletop will be described with reference to FIG. 12. FIG. 12 is a diagram (3) for describing the display control process according to the third modification.

The example of FIG. 12 illustrates a state in which user 10 selects a virtual object 305 displayed behind the face 50 using a touch pen 300 that is a virtual pointer for coordinate designation on the face 50. Note that the touch pen 300 is displayed, for example, when the user 10 brings the stereoscopic device 20 close to a tabletop, and is operated based on IMU information or the like of the stereoscopic device 20.

Note that, in the case of the example of FIG. 12, since the virtual object 305 is located behind the face 50, that is, under the desk face, the desk face interferes with the real movement, and the virtual object 305 cannot be selected with the touch pen 300 using the stereoscopic device 20. Therefore, the display control device 100 performs adjustment related to the selection operation.

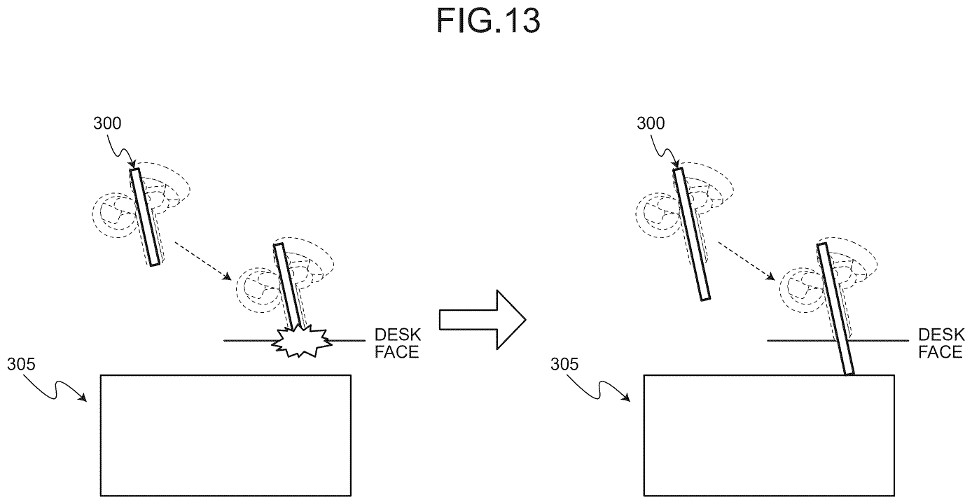

Specifically, when the display control unit 134 virtually displays an object and a pointer (in this example, the touch pen 300) for selecting the object in the three-dimensional space of the real space, the second detection unit 133 may control the size or the contact point of the pointer so that the user 10 is allowed to virtually contact the object using the pointer. This point will be described with reference to FIG. 13. FIG. 13 is a diagram (4) for describing the display control process according to the third modification.

The left part of FIG. 13 illustrates an example in which display control device 100 moves the touch pen 300 by the movement amount same as that of the actual movement of the stereoscopic device 20. In this case, the touch pen 300 collides with the desk face, and the feeling that the user 10 touches the virtual object 305 cannot be obtained.

Therefore, when recognizing that the virtual object 305 is behind the face 50, the display control device 100 dynamically changes the length of the touch pen 300 as illustrated on the right side of FIG. 13. Specifically, when the touch pen 300 comes into contact with the virtual object 305, the display control device 100 adjusts the stereoscopic device 20 so that the stereoscopic device actually collides with the desk face. As a result, the display control device 100 can provide accurate haptic feedback to the user 10, and can perform the accurate display control process that does not pass through the virtual object 305.

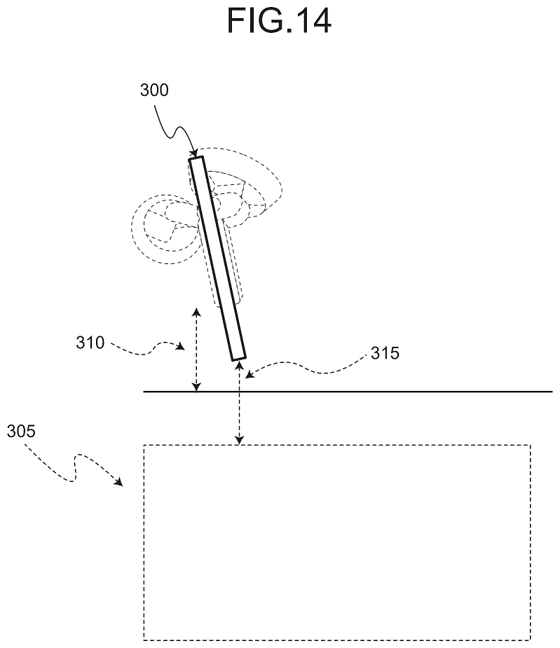

FIG. 14 illustrates an example of display of the touch pen 300. FIG. 14 is a diagram (5) for describing the display control process according to the third modification.

For example, the display control device 100 determines the length of the touch pen 300 based on the distance to the virtual object 305 that the user 10 intends to select. Specifically, the display control device 100 sets a distance 310 between the desk face and the stereoscopic device 20 to be the same as a distance 315 between the tip of the touch pen 300 and the virtual object 305.

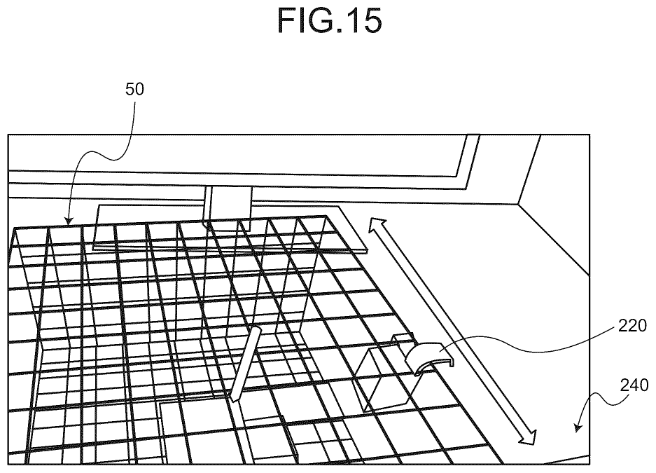

Furthermore, the user 10 can change the size of the face 50 according to the situation of the work place. That is, the first detection unit 132 may control the position and the size of the face 50 virtually displayed in the real space based on the operation of the stereoscopic device 20 by the user 10. This point will be described with reference to FIG. 15. FIG. 15 is a diagram (6) for describing the display control process according to the third modification.

In the example illustrated in FIG. 15, the user 10 performs work using the face 50 pasted on the desk 240. At this time, the user 10 can expand the face 50 so as to cover the face of the desk 240 by performing an operation of expanding the face 50 by gripping the handle 220. That is, the display control device 100 expands or contracts the size of the face 50 according to the operation by the user 10. As a result, the user 10 can effectively use the plane in the real space to which the face 50 is pasted, and thus, can obtain better operability.

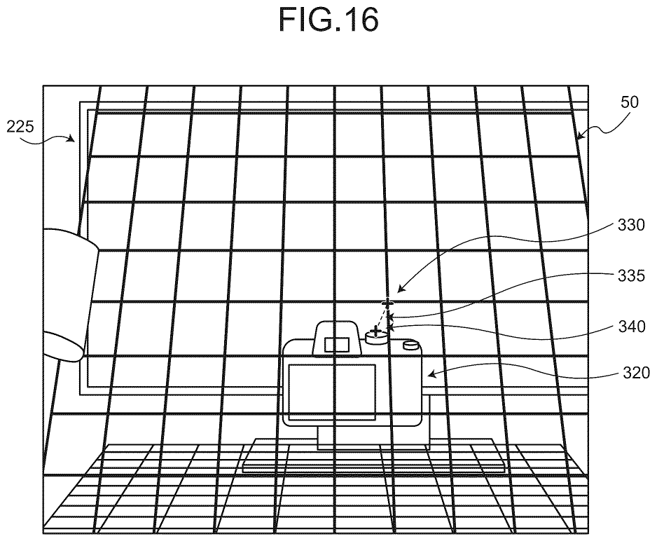

Furthermore, when the user 10 selects a virtual object, the display control device 100 may perform control so that appropriate selection is allowed to be performed by extending a designated position or the like. That is, the second detection unit 133 may extend the selection position by the pointer and control the operation of the pointer so that the user 10 can virtually operate the object. This point will be described with reference to FIG. 16. FIG. 16 is a diagram (7) for describing the display control process according to the third modification.

In the example of FIG. 16, the face 50 is displayed at an angle of 45 degrees with respect to the display 225. Furthermore, a camera 320 that is a virtual object is displayed behind the face 50. In this case, the user 10 cannot directly operate the camera 320 since it is not on the face 50.

At this time, the display control device 100 extends a ray from a pointer 330 displayed by the user 10, and displays a guide 335 indicating the extended line and a pointer 340 which is an intersection of the guide 335 and the camera 320. As a result, the user 10 can operate the camera 320 using the extended pointer 330 even if the pointer 340 cannot be moved to a position where the user actually touches the camera 320.

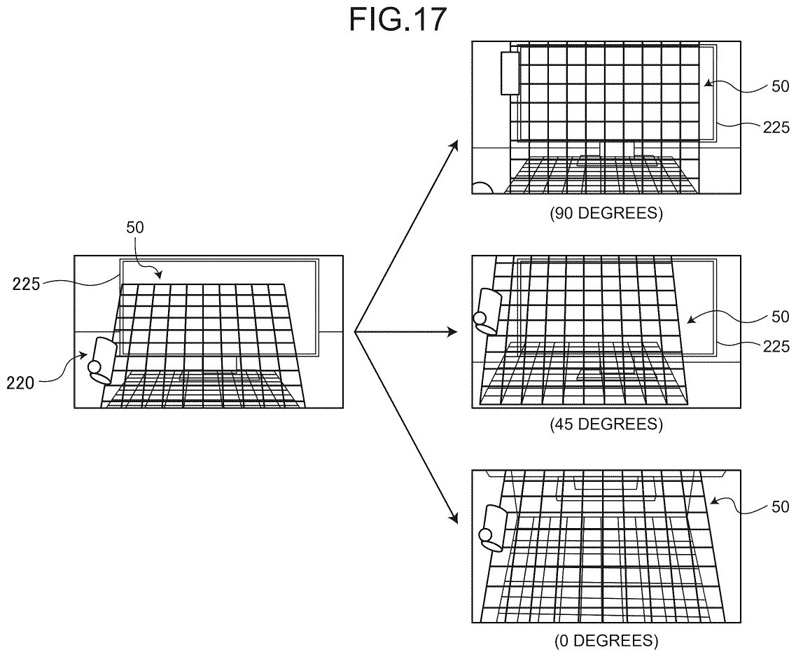

The display control device 100 can display the face 50 at any angle in the AR display. This point will be described with reference to FIG. 17. FIG. 17 is a diagram (8) for describing the display control process according to the third modification.

In the example of FIG. 17, the user 10 grips the handle 220 and moves the face 50. In this case, with respect to the plane in the space (in this example, the screen of the display 225), the display control device 100 may display the face 50 at a right angle (90 degrees) with respect to the screen of the display 225, or may display the face 50 at an angle of oblique 45 degrees or an angle of 0 degrees (that is, a desk face). That is, since the display control device 100 can receive any angle from the user 10, it is possible to construct a work area according to a desire of the user 10.

Note that, in a case where the user 10 desires to design or edit a virtual object, the display control device 100 may display the face 50 at a position offset by a predetermined distance with respect to the target object. In this case, since the user 10 can perform a selection operation on the face 50 offset from the object or work such as sketching the object, a work environment with excellent visibility can be obtained.

### 1-4-4. Fourth Modification: Deformation of Face Based on Pointer Position

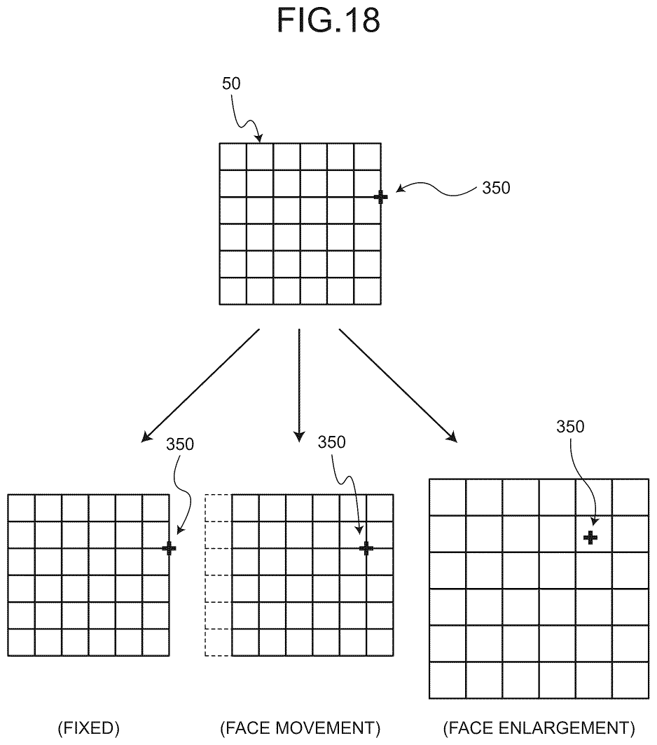

The display control device 100 may change the size of the face 50 itself according to the operation by the user 10. That is, second detection unit 133 may perform the control so that the position or the size of the face 50 is changed based on the position (for example, the display position of the pointer) designated on the face 50 by the user 10. This point will be described with reference to FIG. 18. FIG. 18 is a diagram for describing a display control process according to the fourth modification.

In the upper example of FIG. 18, a pointer 350 is displayed at the right end with respect to the face 50. In this case, the display control device 100 may fixedly display the face 50 and the pointer 350 as illustrated in the lower left part of FIG. 18. Furthermore, the display control device 100 may move the face 50 to the right side at the timing when the pointer 350 reaches the right end as in the lower central part of FIG. 18. Furthermore, the display control device 100 may enlarge and display the face 50 at the timing when the pointer 350 reaches the right end as illustrated in the lower right part of FIG. 18. The display control device 100 may switch the display control process by selection of the user 10. As a result, the user 10 can automatically change the work area in accordance with the movement of the pointer 350, so that better operability can be obtained.

### 2. Other Embodiments

The processing according to each embodiment described above may be performed in various different forms other than the embodiments described above.

Further, it is also possible to manually perform all or part of the processing described as being performed automatically in the processing described in the above embodiment, or alternatively, it is also possible to automatically perform all or part of the processing described as being performed manually by a known method. In addition, the processing procedure, specific name, and information including various pieces of data and parameters illustrated in the above document and drawings is allowed to be arbitrarily changed unless otherwise specified. For example, the various types of information illustrated in each figure are not limited to the illustrated information.

Further, each component of each of the illustrated devices is a functional concept, and does not necessarily have to be physically configured as illustrated in the figure. That is, the specific form of distribution/integration of each device is not limited to the one illustrated in the figure, and all or part of the device is allowed to be functionally or physically distributed/integrated in any unit according to various loads and usage statuses.

Further, the above-described embodiments and modifications is allowed to be appropriately combined in a range where the processing details do not contradict each other.

Further, the effects described in the present specification are merely examples and are not limiting, and other effects may be present.

### 3. Effects of Display Control Device According to Present Disclosure

As described above, the display control device (display control device 100 in the embodiment) according to the present disclosure includes an acquisition unit (acquisition unit 131 in the embodiment) and a display control unit (display control unit 134 in the embodiment). The acquisition unit acquires the position and orientation information in the three-dimensional space from the first controller (stereoscopic device 20 in the embodiment). The display control unit displays a virtual coordinate plane (face 50 in the embodiment) on which two-dimensional coordinates are allowed to be designated in the three-dimensional space based on the position and orientation information in the three-dimensional space.

As described above, the display control device according to the present disclosure can further display the plane on which two-dimensional coordinate are allowed to be designated in the three-dimensional space, thereby improving input accuracy such as pointing to a specific place of the object in the space.

In addition, the display control device includes a first detection unit (first detection unit 132 in the embodiment) that detects the movement of the virtual coordinate plane in the three-dimensional space based on the input by the first controller. For example, the first detection unit detects a movement of an object whose position is allowed to be designated using a virtual coordinate plane based on an input by the first controller.

As described above, the display control device performs control so that the user can freely move the face using the VR controller or the like. As a result, the user can perform an input operation with a high degree of freedom.

In addition, the display control device detects a position designated on the virtual coordinate plane based on an input by the second controller (plane device 30 in the embodiment). For example, the second detection unit detects a part selected in the object based on a position designated on the virtual coordinate plane. Specifically, the second detection unit detects the part selected in the object based on the angle of the virtual coordinate plane and the position designated by the user on the virtual coordinate plane.

As described above, since the display control device acquires an input from the user using the plane device such as a mouse, it is possible to receive an accurate input as compared with the VR controller or the like.

In addition, the second detection unit may detect a point intersecting with the object on an extension line in the normal direction with respect to the virtual coordinate plane with the designated position as a starting point, or a point intersecting with the object on an extension line of a line connecting the viewpoint position of the user and the designated position as the selected part in the object.

In this manner, the display control device can optionally switch the behavior of determining the part selected by the pointer on the face. As a result, the user can avoid behavior that is stressful for the user, such as selection of an erroneous position depending on the pointer position, and can realize desired operability of the user.

In the display control process executed by the display control device, the first controller and the second controller may be the same device. In this case, the first detection unit may detect the same device as the first controller when the same device is located at a position away from the plane in the real space by a predetermined distance. In addition, in a case where the same device is located within a predetermined distance from a plane in the real space, the second detection unit may detect the same device as the second controller. Alternatively, the first detection unit may detect the same device as the first controller in a case of receiving designation to use the same device as the first controller from a user of the same device. The second detection unit may detect the same device as the second controller in a case of receiving designation to use the same device as the second controller from a user of the same device.

As described above, since the display control device can realize the display control process according to the present disclosure with one device, it is possible to provide the user with information processing for realizing high input accuracy even under various facility environments.

In addition, the display control unit displays the virtual coordinate plane in the three-dimensional space based on the viewpoint position of the user regardless of the position and orientation information of the first controller in the three-dimensional space.

As described above, the display control device can reduce the operation procedure of the user by fixing and displaying the face, so that the information processing with less burden on the user can be realized.

In addition, the display control unit displays the virtual coordinate plane in the three-dimensional space of the real space. The first detection unit detects, based on an input from the first controller, in a case where the virtual coordinate plane approaches any plane in the real space by a predetermined distance, the virtual coordinate plane at a position attracted to the plane so that the virtual coordinate plane is superimposed and displayed on the plane.

As described above, the display control device can realize a behavior of the face snapping to the plane of the real space. As a result, the user can easily set a place where the plane device on the tabletop can be easily used as a face, so that work efficiency is allowed to be improved.

In addition, the display control unit virtually displays an object and a pointer for selecting the object in the three-dimensional space of the real space. The second detection unit controls a size or a contact point of the pointer so that the user is allowed to virtually contact the object using the pointer.

As described above, the display control device adjusts the size of the pointer and the contact point (that is, the feedback sensation) in accordance with the real space, thereby providing the user with the operational feeling according to the sense of the real space.

In addition, the first detection unit controls the position and the size of the virtual coordinate plane virtually displayed in the real space based on the operation of the first controller by the user.

As described above, the display control device enables the user to freely adjust the work area by freely changing the size of the face according to the user's desire, so that the operability can be improved.

In addition, the second detection unit extends the selection position by the pointer and controls the operation of the pointer so that the user is allowed to virtually operate the object.

As described above, the display control device can improve the operability of the user by performing the processing of eliminating the inconvenience of the virtual space such as the object being located far away.

In addition, the second detection unit performs control to change the position or the size of the virtual coordinate plane based on the position designated on the virtual coordinate plane by the user.

As described above, the display control device can provide the user with a comfortable work environment by freely changing the size of the face according to the position of the pointer.

### 4. Hardware Configuration

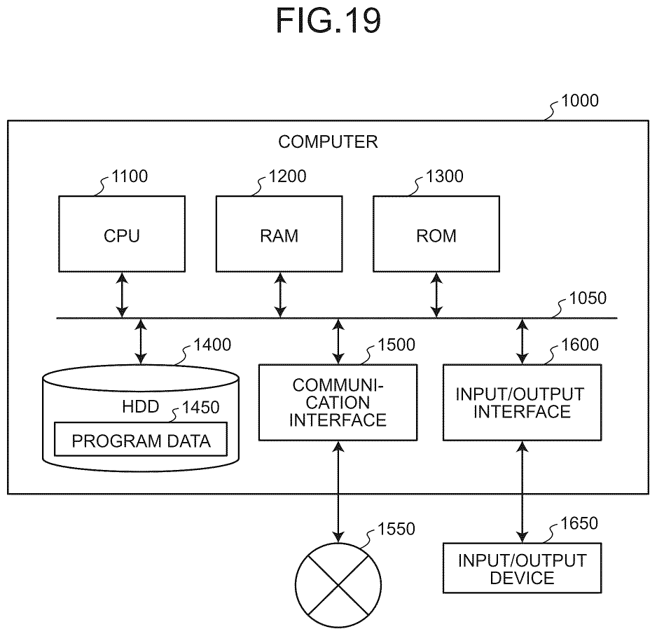

The information device such as the display control device 100 according to each embodiment described above is realized by a computer 1000 having a configuration as illustrated in FIG. 19, for example. Hereinafter, the display control device 100 will be described as an example. FIG. 19 is a hardware configuration diagram illustrating an example of the computer 1000 that implements the functions of the display control device 100. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and performs a process corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records a display control program according to the present disclosure, which is an example of the program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface that connects an input/output device 1650 and the computer 1000. For example, the CPU 1100 receives data from an input device such as a keyboard and a mouse via the input/output interface 1600. In addition, the CPU 1100 transmits data to an output device such as a display, an edge, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the display control device 100 according to the embodiment, the CPU 1100 of the computer 1000 realizes the functions of the control unit 130 and the like by executing the display control program loaded on the RAM 1200. In addition, the HDD 1400 stores a display control program according to the present disclosure and data in the storage unit 120. The CPU 1100 reads the program data 1450 from the HDD 1400 and executes the program data, but as another example, the program may be acquired from another device via the external network 1550.

The present technology may also be configured as below.
(1) A display control device comprising:
   an acquisition unit that acquires position and orientation information in a three-dimensional space from a first controller; and
   a display control unit that displays a virtual coordinate plane on which two-dimensional coordinates are allowed to be designated in the three-dimensional space based on the position and orientation information in the three-dimensional space.
(2) The display control device according to (1), further comprising:
   a first detection unit that detects a movement of the virtual coordinate plane in the three-dimensional space based on an input by the first controller.
(3) The display control device according to (2), wherein
   the first detection unit
   detects a movement of an object whose position is allowed to be designated using the virtual coordinate plane based on an input by the first controller.
(4) The display control device according to (2) or (3), further comprising:
   a second detection unit that detects a position designated on the virtual coordinate plane based on an input from a second controller.
(5) The display control device according to (4), wherein
   the second detection unit
   detects a part selected in an object based on the position designated on the virtual coordinate plane.
(6) The display control device according to (5), wherein
   the second detection unit
   detects a part selected in the object based on an angle of the virtual coordinate plane and a position designated by a user on the virtual coordinate plane.
(7) The display control device according to (6), wherein
   the second detection unit
   detects, as the part selected in the object, a point intersecting with the object on an extension line in a normal direction with respect to the virtual coordinate plane with the designated position as a starting point, or a point intersecting with the object on an extension line of a line connecting a viewpoint position of a user and the designated position.
(8) The display control device according to any one of (4) to (7), wherein
   the first controller and the second controller are a same device.
(9) The display control device according to (8), wherein
   the first detection unit
   detects the same device as the first controller in a case where the same device is located at a position away from a plane in a real space by a predetermined distance, and
   the second detection unit
   detects the same device as the second controller in a case where the same device is located within a predetermined distance from a plane in a real space.
(10) The display control device according to (8), wherein
   the first detection unit
   detects the same device as the first controller in a case where designation to use the same device as the first controller is received from a user of the same device, and
   the second detection unit
   detects the same device as the second controller in a case where designation to use the same device as the second controller is received from a user of the same device.
(11) The display control device according to any one of (2) to (10), wherein
   the display control unit
   displays the virtual coordinate plane in the three-dimensional space based on a viewpoint position of a user regardless of the position and orientation information of the first controller in the three-dimensional space.
(12) The display control device according to any one of (5) to (7), wherein
   the display control unit
   displays the virtual coordinate plane in the three-dimensional space of a real space, and
   the first detection unit
   detects, based on an input by the first controller, in a case where the virtual coordinate plane approaches any plane in a real space by a predetermined distance, the virtual coordinate plane at a position attracted to the plane so that the virtual coordinate plane is superimposed and displayed on the plane.
(13) The display control device according to (12), wherein
   the display control unit
   virtually displays the object and a pointer for selecting the object in the three-dimensional space of the real space, and
   the second detection unit
   controls a size or a contact point of the pointer so that a user is allowed to virtually contact the object using the pointer.
(14) The display control device according to (12) or (13), wherein
   the first detection unit
   controls a position and a size of the virtual coordinate plane virtually displayed in a real space based on an operation of the first controller by a user.
(15) The display control device according to (13), wherein
   the second detection unit
   extends a selection position by the pointer and controls an operation of the pointer so that a user is allowed to virtually operate the object.
(16) The display control device according to any one of (4) to (7), wherein
   the second detection unit
   performs controls so as to change a position or a size of the virtual coordinate plane based on the position designated on the virtual coordinate plane by a user.
(17) A display control method executed by a computer, the method comprising:
   acquiring position and orientation information in a three-dimensional space from a first controller; and
   displaying a virtual coordinate plane on which two-dimensional coordinates are allowed to be designated in the three-dimensional space based on the position and orientation information in the three-dimensional space.

### REFERENCE SIGNS LIST

1 DISPLAY CONTROL SYSTEM
10 USER
20 STEREOSCOPIC DEVICE
30 PLANE DEVICE
50 FACE
100 DISPLAY CONTROL DEVICE
110 COMMUNICATION UNIT
120 STORAGE UNIT
130 CONTROL UNIT
131 ACQUISITION UNIT
132 FIRST DETECTION UNIT
133 SECOND DETECTION UNIT
134 DISPLAY CONTROL UNIT
140 SENSOR UNIT
150 DISPLAY UNIT

1. A display control device comprising:
an acquisition unit that acquires position and orientation information in a three-dimensional space from a first controller; and
a display control unit that displays a virtual coordinate plane on which two-dimensional coordinates are allowed to be designated in the three-dimensional space based on the position and orientation information in the three-dimensional space.

2. The display control device according to claim 1, further comprising:
a first detection unit that detects a movement of the virtual coordinate plane in the three-dimensional space based on an input by the first controller.

3. The display control device according to claim 2, wherein
the first detection unit
detects a movement of an object whose position is allowed to be designated using the virtual coordinate plane based on an input by the first controller.

4. The display control device according to claim 2, further comprising:
a second detection unit that detects a position designated on the virtual coordinate plane based on an input from a second controller.

5. The display control device according to claim 4, wherein
the second detection unit
detects a part selected in an object based on the position designated on the virtual coordinate plane.

6. The display control device according to claim 5, wherein
the second detection unit
detects a part selected in the object based on an angle of the virtual coordinate plane and a position designated by a user on the virtual coordinate plane.

7. The display control device according to claim 6, wherein
the second detection unit
detects, as the part selected in the object, a point intersecting with the object on an extension line in a normal direction with respect to the virtual coordinate plane with the designated position as a starting point, or a point intersecting with the object on an extension line of a line connecting a viewpoint position of a user and the designated position.

8. The display control device according to claim 4, wherein
the first controller and the second controller are a same device.

9. The display control device according to claim 8, wherein
the first detection unit
detects the same device as the first controller in a case where the same device is located at a position away from a plane in a real space by a predetermined distance, and
the second detection unit
detects the same device as the second controller in a case where the same device is located within a predetermined distance from a plane in a real space.

10. The display control device according to claim 8, wherein
the first detection unit
detects the same device as the first controller in a case where designation to use the same device as the first controller is received from a user of the same device, and
the second detection unit
detects the same device as the second controller in a case where designation to use the same device as the second controller is received from a user of the same device.

11. The display control device according to claim 2, wherein
the display control unit
displays the virtual coordinate plane in the three-dimensional space based on a viewpoint position of a user regardless of the position and orientation information of the first controller in the three-dimensional space.

12. The display control device according to claim 5, wherein
the display control unit
displays the virtual coordinate plane in the three-dimensional space of a real space, and
the first detection unit
detects, based on an input by the first controller, in a case where the virtual coordinate plane approaches any plane in a real space by a predetermined distance, the virtual coordinate plane at a position attracted to the plane so that the virtual coordinate plane is superimposed and displayed on the plane.

13. The display control device according to claim 12, wherein
the display control unit
virtually displays the object and a pointer for selecting the object in the three-dimensional space of the real space, and
the second detection unit
controls a size or a contact point of the pointer so that a user is allowed to virtually contact the object using the pointer.

14. The display control device according to claim 12, wherein
the first detection unit
controls a position and a size of the virtual coordinate plane virtually displayed in a real space based on an operation of the first controller by a user.

15. The display control device according to claim 13, wherein
the second detection unit
extends a selection position by the pointer and controls an operation of the pointer so that a user is allowed to virtually operate the object.

16. The display control device according to claim 5, wherein
the second detection unit
performs controls so as to change a position or a size of the virtual coordinate plane based on the position designated on the virtual coordinate plane by a user.

17. A display control method executed by a computer, the method comprising:
acquiring position and orientation information in a three-dimensional space from a first controller; and
displaying a virtual coordinate plane on which two-dimensional coordinates are allowed to be designated in the three-dimensional space based on the position and orientation information in the three-dimensional space.
